(19) United States
(12) Patent Application Publication
(10) Pub. No.: US 2006/0053149 A1
(43) Pub. Date: Mar. 9, 2006

(54) Method and system for supporting development of information systems based on EA

(76) Inventors: Atsushi Iwasaki, Yokohama (JP); Masaya Shozui, Musashino (JP); Yuji Ishii, Kawasaki (JP); Eiji Takamatsu, Yokosuka (JP); Takeshi Matsuoka, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/050,136

(22) Filed: Feb. 4, 2005

(30) Foreign Application Priority Data
Sep. 8, 2004 (JP) 2004-260416

(51) Int. Cl. G06F 17/00

(52) U.S. Cl. 707/102

(57) ABSTRACT

The man-months definition table 106 defines man-months for each combination of a function, data, and an infrastructure for both As_Is and To_Be of EA. The content retrieval patterns database 109 sets a development example for each combination of the function, data and the infrastructure. The EA result analysis unit 113 creates a retrieval pattern used for retrieving man-months from EA planning results of the EA planning results database 108, and the man-months calculation unit 114 searches the man-months definition table 106 to calculate development man-months. The example retrieval unit 115 creates a retrieval pattern used for retrieving content and searches the content retrieval patterns database 109 for a suitable development example.

### CLAIM OF PRIORITY

The present application claims priority from the Japanese patent application JP2004-260416 filed on Sep. 8, 2004, the content of which is hereby incorporated by reference into this application.

### BACKGROUND OF THE INVENTION

1. Field of the Invention

The present invention relates to a method for supporting a particular system development after planning of an Enterprise Architecture (EA), and more specifically to a method for aiding calculation of man-months, preparation of schedules and retrieval of past examples, in terms of a particular information system in accordance with the relationship of four EA layers.

2. Description of Related Arts

EA is a model to standardize work procedures or information systems of organizations such as enterprises and governmental agencies, and execute design, construction and operation of system development from the viewpoint of optimization of the whole organization while focusing on the relationship between different divisions and that between layers of the information systems. Well-known methods include a method wherein the present status (As_Is) and the ideal status (To_Be) of an enterprise information system are respectively expressed by using four mutually-related models of Job (BA: Business Architecture), Data (DA: Data Architecture), Application (AA: Application Architecture) and Infrastructure (Technology) (TA: Technology Architecture).

Conventionally, particular systems based on EA have been developed through the following manual work:
(1) Planning of As_Is and To_Be
(2) Measurement of a difference between As_Is and To_Be
(3) Division of the whole enterprise information system into development units of particular systems according to application layers.
(4) Determination of man-months for each development unit.
(5) Determination of development schedule for each development unit
(6) Determination of development schedule for the whole enterprise information system
(7) Creation of design documents for a particular system.

Technologies to support such type of system development include the one wherein, as stated in Japanese Patent Laid-open No. 2002-109173, for example, calculation of man-hours or preparation of schedules of product development is executed by storing an equation for calculating man-hours in a database, and by using parameters, showing a new development or a diverted design, which is entered by a user.

### BRIEF SUMMARY OF THE INVENTION

So far, it is true that technologies which define development man-months of or development schedules for a single information system existed. However, a technology which creates a development schedule of a plurality of particular systems by estimating development man-months at a time has not been found. In addition, since four-layer structure used in EA is not focused in prior arts, they are not suitable for calculating development man-months or preparing development schedules for the entire enterprise information system from the EA planning results.

Development of particular systems after finishing planning of EA is difficult, because it must be conducted while referring to past adequate examples with an eye to a broad target range, without missing the most suitable concept for the entire system.

In addition, with a system construction based on EA, development of particular systems is usually executed with an application as a unit. Past examples of system development are sorted out on application by application basis, and, in many cases, other functions and information on the the other applications and data related to an application are not put in order. As a result, when referring to past examples at the time of system development, retrieval can only be made by application names, and many man-months as well as time are required to find the most suitable example satisfying the four layers planned in EA from among large numbers of past examples.

Further, since small-size functions are not planned in EA, man-months calculation of a particular system development depends on experience of the person who conducts the calculation, and therefore, the calculation quality cannot be maintained at a certain level.

An object of the present invention is to provide a system which executes estimation of development man-months and retrieval of past examples of a particular system after completing planning of EA, while considering the relationship between the four EA layers.

The present invention relates to a system which supports construction of a particular system based on EA by using an information processor, and the system is configured to calculate development man-months of the particular system based on a database storing EA planning results, thus obtaining the adequate particular development examples. When calculating development man-months, for a man-months definition table which defines man-months according to combinations of As_Is and To_Be functions, data and infrastructure, retrieval is made in retrieval patterns of the combinations. Further, when retrieving development examples, for a content retrieval pattern database which sets past examples according to combinations of functions, data, functions in liaison and infrastructure, retrieval is made in retrieval patterns of the combinations.

### BRIEF DESCRIPTION OF THE DRAWINGS

FIG. 1 is a configuration diagram of a system according to an embodiment of the present invention;

FIG. 2 shows a man-months definition table for each function;

FIG. 3 shows a man-months definition table for each database software;

FIG. 4 shows a terminology master table;

FIG. 5 shows a functional structure table;

FIG. 6 shows a function_data correspondence table;

FIG. 7 shows a data_entity correspondence table;

FIG. 8 shows an application-function configuration table;

FIG. 9 shows an applications relationship table;

FIG. 10 shows an As_Is_To_Be applications correspondence table;

FIG. 11 shows an application_infrastructure correspondence table;

FIG. 12 shows a content retrieval patterns database;

FIG. 13 shows a man-months retrieval key for each function;

FIG. 14 shows a man-months retrieval key for each database software;

FIG. 15 shows an example retrieval key;

FIG. 16 shows a process flow of man-months calculation of a particular system development; and

FIG. 17 shows a process flow of examples retrieval of a particular system development.

### DETAILED DESCRIPTION OF THE INVENTION

Hereinafter, a preferred embodiment of the present invention will be described in detail with reference to the accompanying drawings. Note that the present invention is not limited to the embodiment.

Among four EA layers, a job layer is adapted to systematically define an intra-company organization and jobs to be operated by the organization. A data layer is adapted to represent the details of data required for operating all jobs and the relationship between the data. An application layer is adapted to define groups of information processing functions that generate data required for executing the jobs. An infrastructure layer is adapted to define software and hardware environments that are required for executing processes.

With a system development using EA, a system is usually constructed in such a manner as to draw the current status (As_Is) and ideal status (To_Be) of the system, and then fill in the gap between the two statuses. At this time, construction of the whole enterprise information system at a time carries great risks, and usually, development is executed on the basis of particular systems by dividing the whole system for a certain unit. The system development is usually executed for each application. This is because the application layer is sorted out to enable a judgment as to whether system functions can be realized as required by a customer, and to enable application of practically applicable technologies to the functions.

Hereinafter, the embodiment will be described in detail with reference to the accompanying drawings.

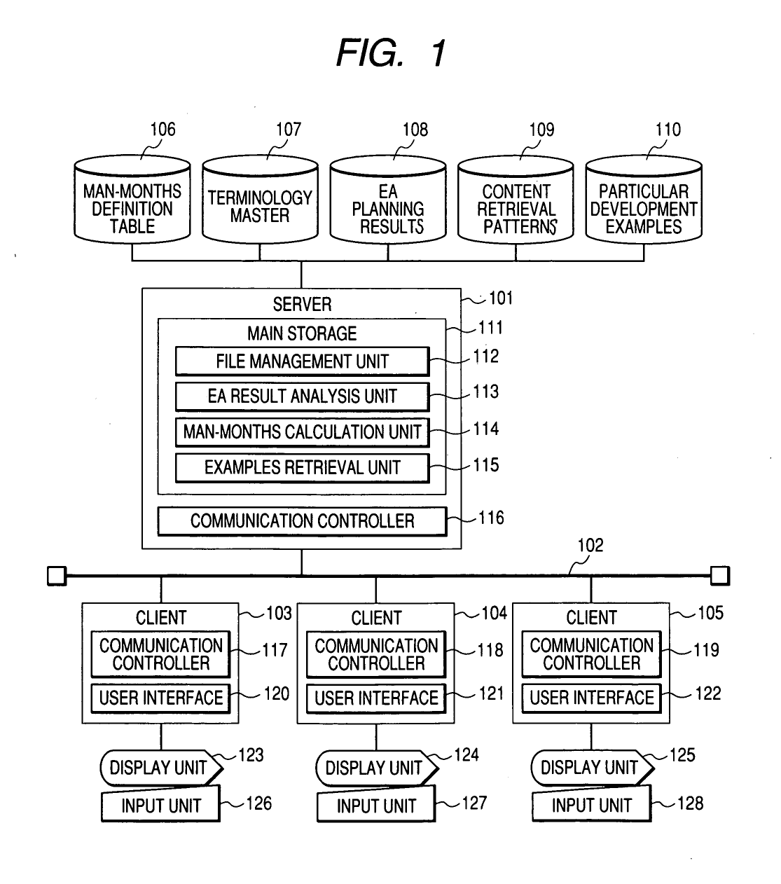

FIG. 1 is a configuration diagram of a system according to the embodiment of the present invention. The system comprises a server 101, clients 103, 104 and 105, and a network 102 which connects the server 101 with clients 103, 104 and 105. The server 101 holds groups of databases, calculates man-months of future particular developments by using the planning results stored in the databases, creates a development schedule and presents past development examples. The clients 103, 104 and 105 input data to the server 101 via the network 102 and displays data received from the server 101. The clients 103, 104 and 105 are not bound up with installation distances or installation places if they are coupled with the network 102, and three clients are provided in FIG. 1, as an example.

A storage device of the server 101 stores a man-months definition table 106, a terminology master database 107, an EA planning results database, a content retrieval patterns database 109 and a particular development examples database 110, as shown in FIG. 1.

Main storage 111 of the server 101 stores the respective programs of a file management unit 112, an EA result analysis unit 113, a man-months calculation unit 114, an examples retrieval unit 115, and it temporarily stores information that is obtained during a process. The file management unit 112 manages accesses to each database and each data that is stored in each database. The EA result analysis unit 113 analyzes EA planning result stored in the EA planning results database 108 and creates a retrieval key to search the man-months definition table 106. The man-months calculation unit 114 searches the example-based man-months definition table 106 by using the retrieval key created by the EA result analysis unit 113, and calculates man-months of a particular development by accumulating man-months data thus obtained. The examples retrieval unit 115 creates an example retrieval key from the EA planning result stored in the EA planning results database 108, searches the content retrieval patterns database 109 by using the example retrieval key thus created, and fetches examples of particular development by searching the particular development examples database 110 by using the result thus obtained. The server 101 further comprises a communication controller 116. The communication controller 116 controls transmission and reception of data to be executed via the network 102 between the server 101 and either client 103, 104 or 105.

The respective communication controllers 117, 118 and 119 of the clients 103, 104 and 105 control transmission and reception of data to be executed with the server 101 via the network 102. Input units 126, 127 and 128 input EA planning results and priorities of particular developments. Display units 123, 124 and 125 display processing results of the server 101. User interfaces 120, 121 and 122 display processing results of the man-months calculation unit 114 of the server 101 and processing results of the examples retrieval unit 115, in accordance with the display screen format that has been screen-designed in advance, and they transmit information that is input from the input units 126, 127 and 128 to the server 101.

The sever 101 and the clients 103, 104 and 105 are each an information processor such as a personal computer or a workstation. The file management unit 112, the EA result analysis unit 113, the man-months calculation unit 114, the examples retrieval unit 115 and user interfaces 120, 121 and 122 are realized by executing corresponding programs to be stored in the main storage of each information processor. The communication controllers 116, 117, 118 and 119 are realized with hardware and software. It should be noted that the groups of databases such as the example-basis man-months definition table 106 and the file management unit 112 of the server 101 may be realized with another server to be connected with the server 101 via a network.

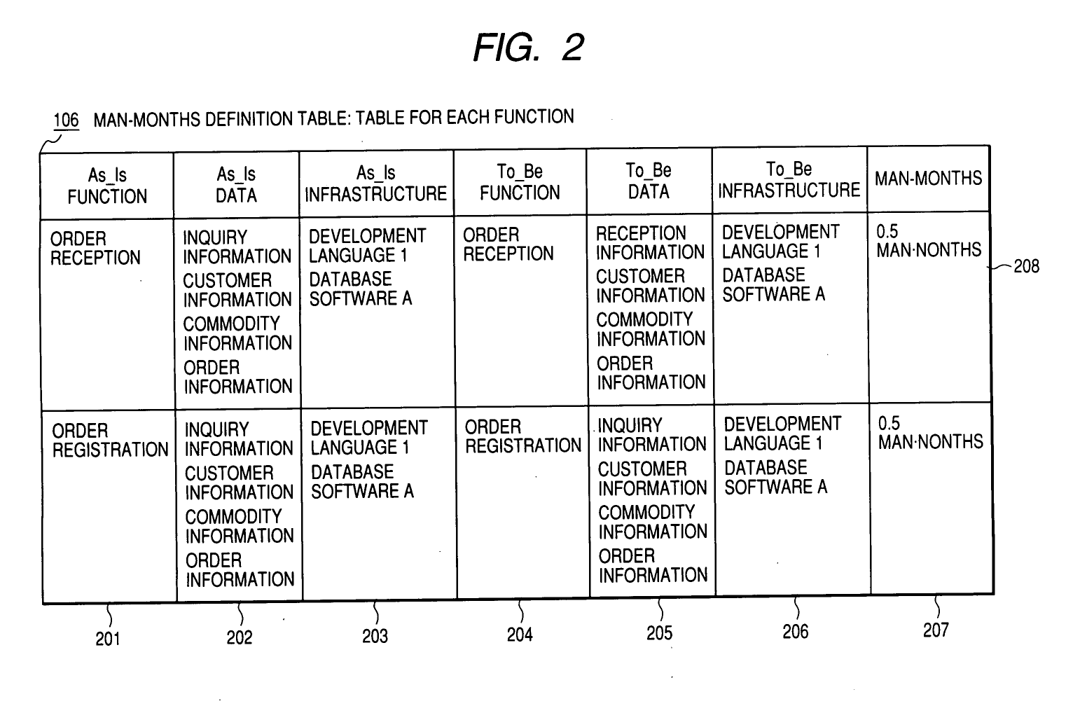

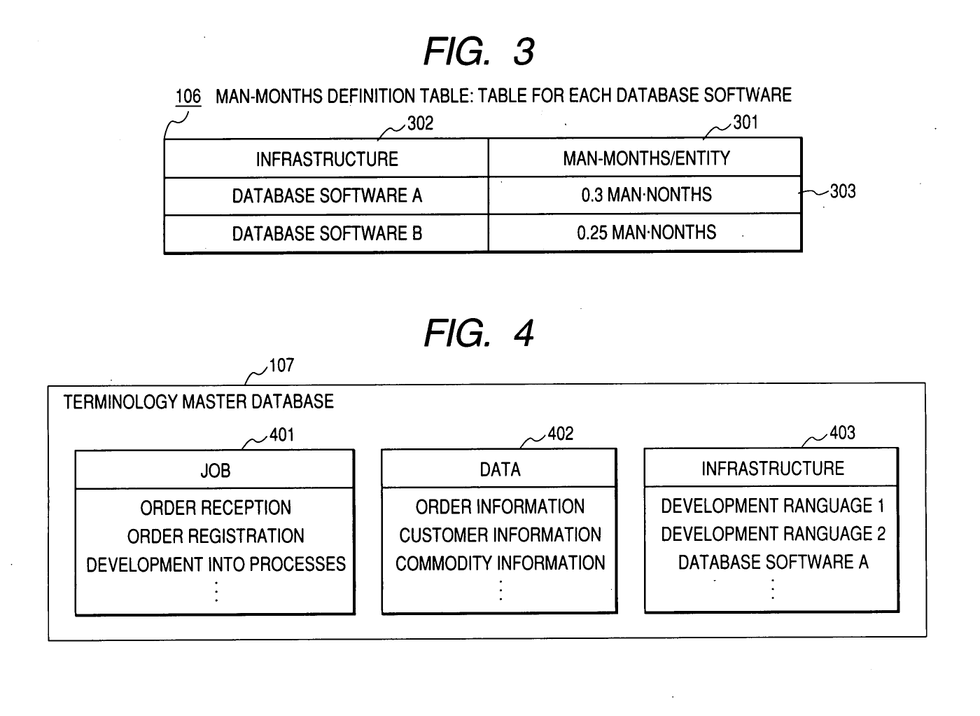

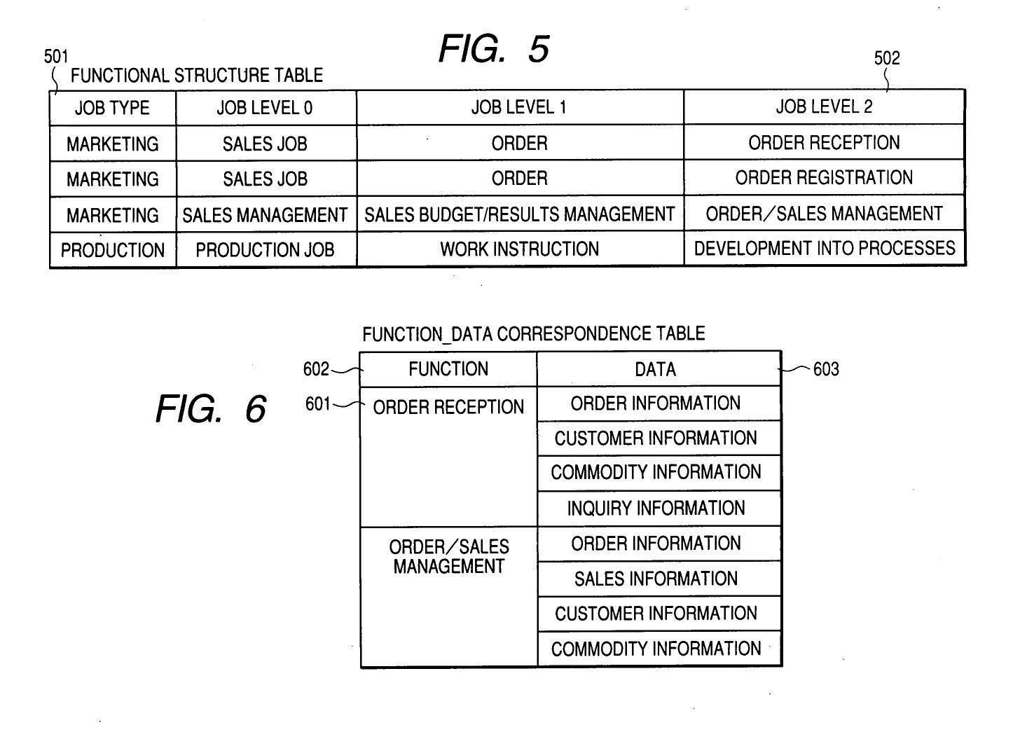

In the exampled-basis man-months definition table 106, information required for calculating man-months as shown in FIGS. 2 and 3 to be described later is stored. The server 101 reads necessary information from the example-basis man-months definition table 106 on calculation of man-months. In addition, the EA planning results database 108 stores EA planning results as shown in FIGS. 5 to 11 (to be described later) that are planned by a user. In the main storage 111 of the server 101, information as shown in FIGS. 13, 14 and 15 to be described later is stored.

FIG. 2 is a diagram showing a man-months definition table for each function. The man-months definition table for each function is stored in the man-months definition table database 106. The table is used to define development man-months for an application to be shifted to To_Be from As_Is based on past examples, while focusing on “function”, “Data” and “infrastructure.” Referring to FIG. 2, for an application, man-months 207 that is incurred when the system is reconstructed to a “function” 204, “data” 205 and an “infrastructure” 206 of To_Be from a “function” 201, “data” 202 and a “infrastructure” 203 of As_Is respectively are defined for each possible combination of “function”, “data” and “infrastructure.” The example of FIG. 2 shows that a job “order” is divided into several functions such as “order reception” and “order registration.” In addition, one function or several inter-related functions correspond to one application. Data 208 shows 0.5 man-months is required for modifying the program or data when a system comprising To_Be function “order reception”, To_Be data “reception information, customer information, commodity information, order information”, and To_Be infrastructure “development language 1, database software A” is constructed from a system comprising As_Is function “order reception”, As_Is data “inquiry information, customer information, commodity information, order information” and As_Is infrastructure “development language 1, database software A.” As for the function “order registration”, there is no modification in “data” and “infrastructure” themselves, but it requires a test, etc. in connection with other functions. Thus, 0.5 man-months is set up here.

FIG. 3 is a diagram showing a man-months definition table for each database software. The man-months definition table for each database software is stored in a man-months definition table database. Here, the term “entity” implies a unit which is used to manage information on a database. The table defines standard man-months 301 which is required to create one entity for each of infrastructures (database software) 302 which will finally manage the entity. Data 303 shows that 0.3 man-months is required to create one entity if the infrastructure is the database software A.

FIG. 4 shows a terminology master database 107. The terminology master database 107 stores terminologies to be used, by categorizing them into a job 401, data 402 and an infrastructure 403. The job 401 is adapted to register a function name in service therewith. The table is used to check if an EA planning result conforms to the job name, data name and infrastructure name that are defined in advance. It should be noted that the job name used here implies a function name to be used in a “job level 2” 502 in a functional structure table 501 shown in FIG. 5 which will be described later, and it does not include a job name to be used in a “job level 0” and a “job level 1.”

FIG. 5 is a diagram showing the functional structure table 501. The functional structure table 501 breaks up jobs to be used for the BA layer (the first layer) of EA into three levels from the “job level 0” to the “job level 2” for each job type. For EA, a method for breaking up job functions in three levels by using a diagram called “job function configuration diagram” is used in general. Thus, in the embodiment, job functions up to the level 2 will be set up to create a diagram or a table which defines a job structure shown in FIG. 5. In the terminology check process which uses the terminology master database (FIG. 4) described earlier, a check will be made on data which is stored in the “job level 2” 502 in the functional structure table 501 concerning jobs.

FIG. 6 shows a function_data correspondence table 601. The function_data correspondence table 601 is used to define what data 603 a function 602 that is defined in the column “job level 2.” 502 in the functional structure table 501 shown in FIG. 5 requires to couple the BA layer (the first layer) and the DA layer (the second layer). Data 601 shows that data required by a function “order reception” is “order information, customer information, commodity information and inquiry information.”

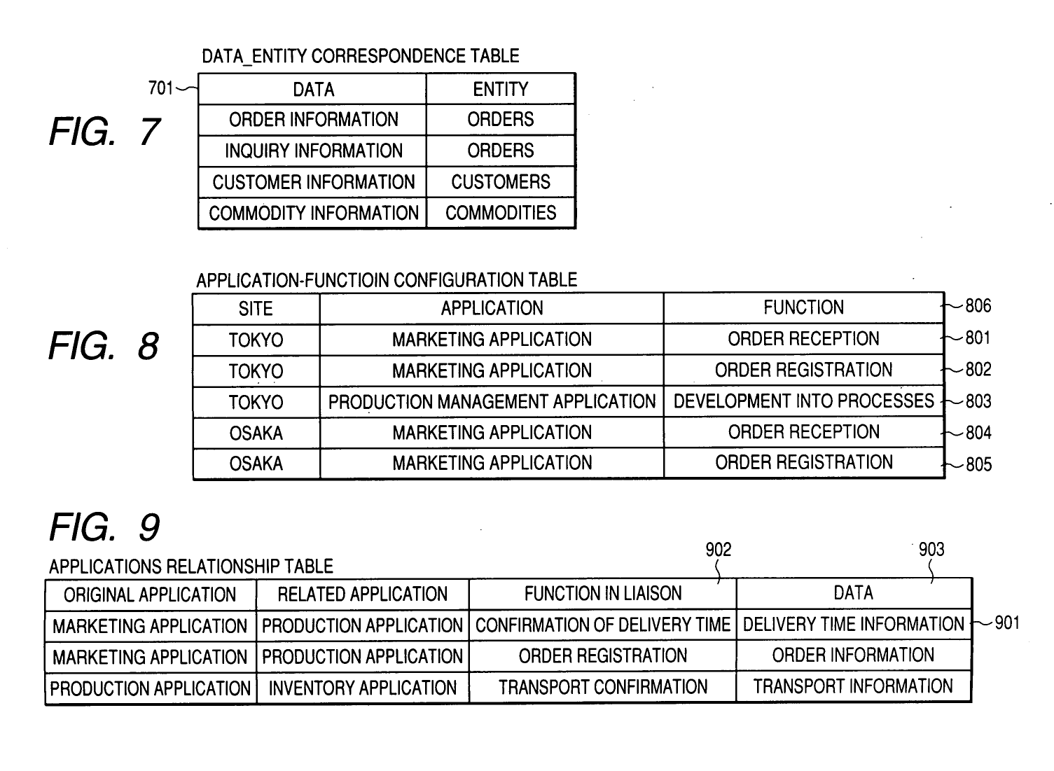

FIG. 7 is a diagram showing a data_entity correspondence table 701. The data_entity correspondence table 701 is used to define correspondence between data set in a data column 603 in the function_data correspondence table 601 (FIG. 6) and an entity defined in the DA layer.

FIG. 8 shows an application-function configuration table. The application-function configuration table is used to define an application to be used at each target site of EA planning, and a function 806 intended for the application in order to couple an AA layer (third layer) with an BA layer (first layer). The example shown in FIG. 8 shows that the site “Tokyo” has a “marketing application” as well as the functions of an “order reception” 801 and an “order registration” 802, and another application “production management application” has a function of “development into processes” 803. The table also shows that a “marketing application” which exists in a site “Osaka” has the functions of an “order reception” 804 and an “order registration” 805 as is the case with Tokyo. In this case, the “marketing application” exists in both Tokyo and Osaka, but they will be defined as different applications.

FIG. 9 shows an applications relationship table. The applications relationship table is used to define two applications (“original application” and “related application”) related to an architecture of the AA layer (the third layer) that is planned in EA, a function in liaison 902 which controls liaison between the applications, and data 903 which is exchanged between the applications. The data 901 shows that a related application called “production application” exchanges data “delivery time information” with the original application called “marketing application” by using a function “confirmation of delivery time.”

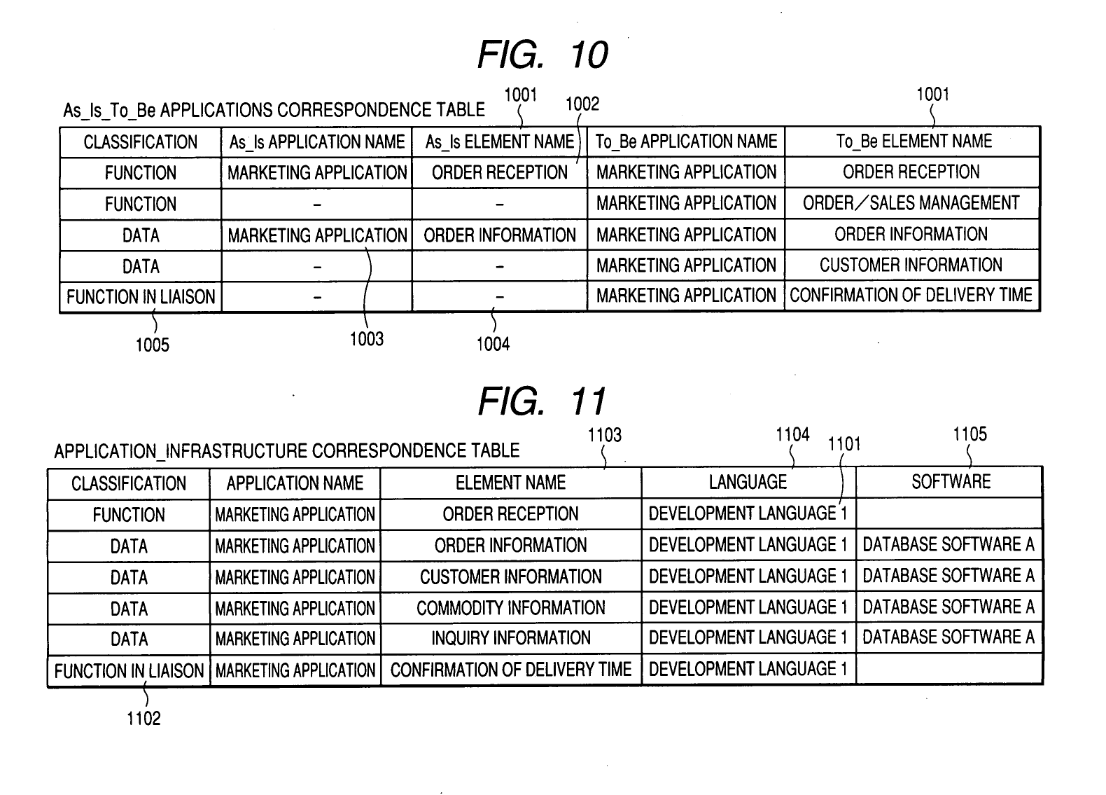

FIG. 10 shows an As_Is_To_Be applications correspondence table. In the As_Is_To_Be applications correspondence table, correspondence between an As_Is application and a To_Be application is defined for each segment of “function”, “data” and “function in liaison.” An As_Is (or To_Be) element name 1001 shows specific function name, data name and function in liaison name in respective segments of “function”, “data” and “function in liaison.” For example, a first line 1002 on the table shows that the “order reception” function which is a “function” segment of the As_Is “marketing application” will be the “order reception” function of the To_Be “marketing application.” A third line 1003 shows that the “order information” data which is a “data” segment of the As_Is “marketing application” will be used as the “order information” data in the To_Be “marketing application.” Further, an element 1004 wherein the As_Is application name or the element name is marked with a hyphen (−) shows that no current element exists, since the element 1004 is an element which corresponds to an application to be developed anew.

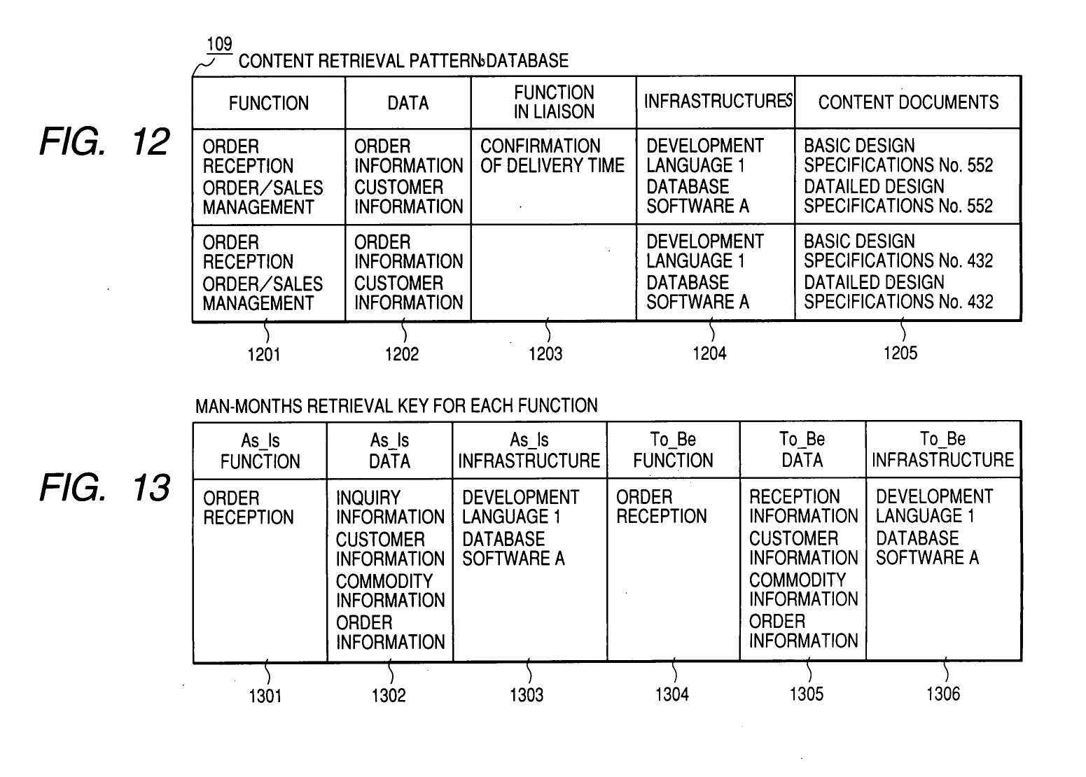

FIG. 11 shows an application_infrastructure correspondence table. The application_infrastructure correspondence table is used to define infrastructures (languages and software) which realize “functions”, “data” and “functions in liaison” of each application to couple the TA layer (the fourth layer) and other three layers. For example, a first line 1101 on the table shows that the “order reception” which is a function of “marketing application” is realized by the “development language 1.” Here, a language column 1104 is used to show a language to be used with development of the application, while a software column 1105 is used to show a database management system to be introduced to manage data.

FIG. 12 shows a content retrieval patterns table. The content retrieval patterns table is stored in the content retrieval patterns database 109 (FIG. 1). The table is used to define names of content documents 1205 which are accumulated through particular development examples for each combination of a “function” 1201, “data” 1202, a “function in liaison” 1203 and “infrastructures” 1204. A combination of terminologies to be used in the “function”, the “data”, the “function in liaison” and the “infrastructures” in the definition table will be a content retrieval pattern. The table shows an example of two content retrieval patterns: the upper column shows a retrieval pattern for a case where a “function in liaison” exists; and the lower column shows another retrieval pattern for a case where a “function in liaison” does not exist. It should be noted that, in the particular development examples database 110, actual design specifications of all particular development examples that are defined in the content retrieval patterns database 109 are stored.

FIG. 13 shows a man-months retrieval key for each function. The man-months retrieval key for each function is stored in the main storage 111. The man-months retrieval key for each function is information to be created as a key to search the man-months definition table 106 (FIG. 2), and it comprises six rows of an “As_Is function” 1301, an “As_Is data” 1302, an “As_Is infrastructure” 1303, a “To_Be function” 1304, a “To_Be data” 1305 and a “To_Be infrastructure” 1306. For one function, a combination of all terminologies that appear in the six rows will be the retrieval key.

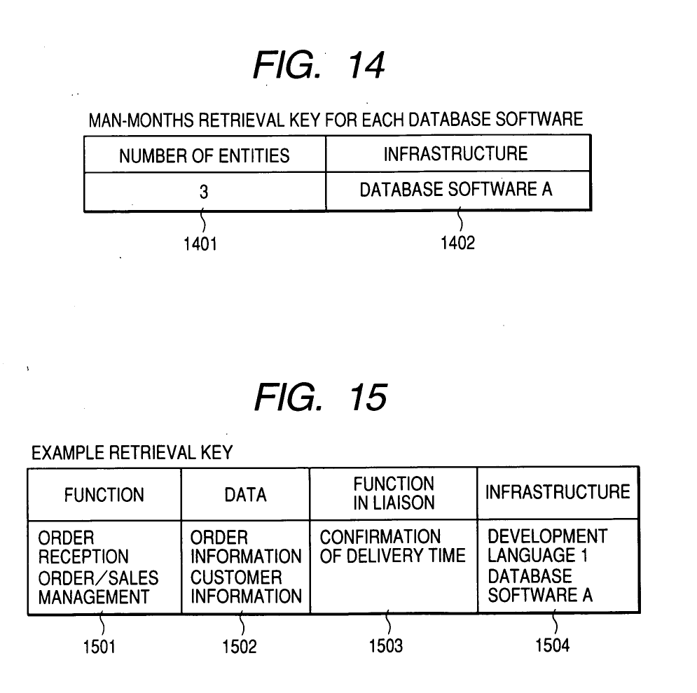

FIG. 14 shows a man-months retrieval key for each database software and the key is stored in the main storage 111. The man-months retrieval key for each database software is information to be created as a retrieval key that is used to calculate man-months based on information contained in the example-basis man-months definition table 106 (FIGS. 2 and 3). In addition, the key is configured in two rows of a “number of entities” 1401 and an “infrastructure” 1402. Here, an infrastructure name will be the retrieval key.

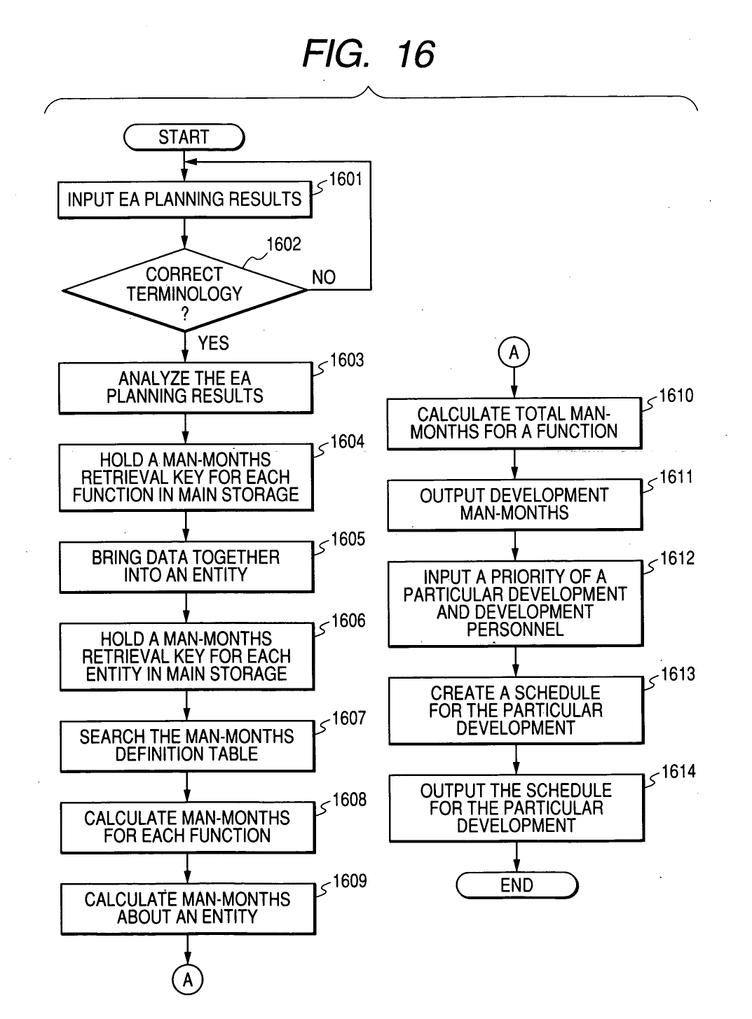

FIG. 15 shows an example retrieval key, which is stored in the main storage 111. The example retrieval key is information to be created as a key to search the content retrieval patterns database 109 (FIG. 12) which stores past examples therein. In addition, the key is configured with four rows of a “function” (1501), “data” (1502), a “function in liaison” (1503) and an “infrastructure” (1504). Combinations of terminologies in the four rows are used for retrieval as content retrieval patterns.

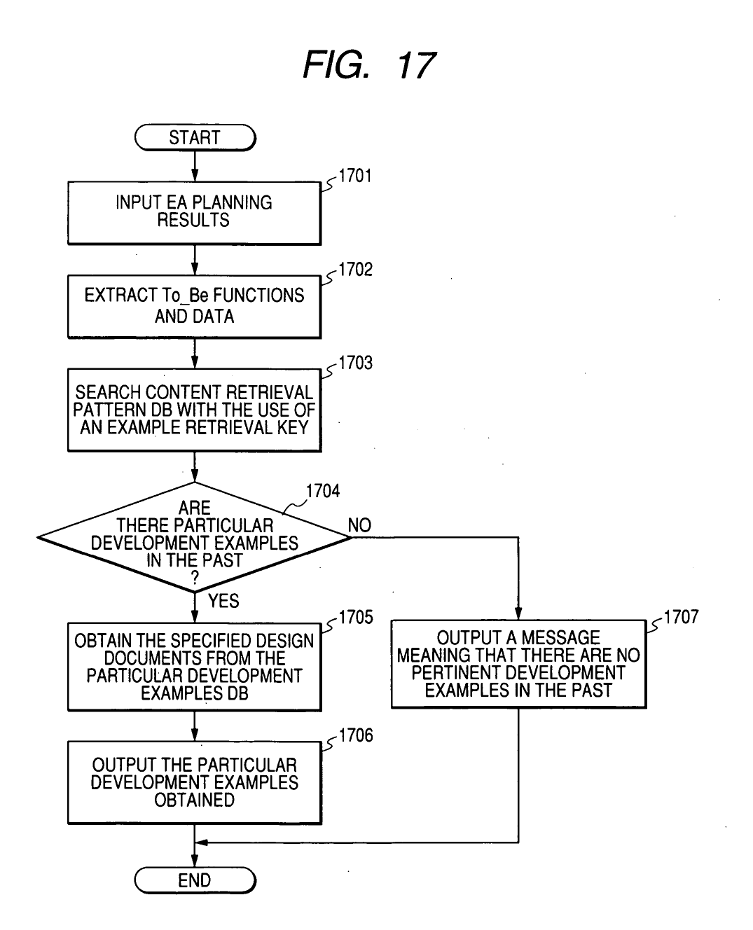

FIG. 16 is a flow chart showing a specific process flow of the embodiment. First, a user inputs all information shown in the tables in FIGS. 5 to 11 as deliverables of EA via client input units 126, 127 and 128. The information thus input is transmitted to the server 101, and the EA result analysis unit 113 of the server 101 receives such information (Step 1601).

The EA result analysis unit 113 temporarily stores the planning results of EA thus input in the EA planning results database 108 and checks if the planning results use terminologies that are defined in the terminology master database 107 (Step 1602).

As for terminologies defined in the job 401 of the terminology master database 107, the columns and lines to be checked include: the column “job level 2” 502 in the “functional structure table” in FIG. 5; the column “function” 602 in the “function_data correspondence table” in FIG. 6; the column “function” 806 in the “application-function configuration table” in FIG. 8; the column “function in liaison” 902 in the “applications relationship table” in FIG. 9; the column “As_Is element name” and the column “To_Be element name“ 1001 of the line in which “function” and “function in liaison” are stated in the column “Classification” 1005 in the “As_Is_To_Be application correspondence table” in FIG. 10; and the column “element name” 1103 of the line in which “function” and “function in liaison” are stated in the column “Classification” 1102 in the “application_infrastructure correspondence table” in FIG. 11.

As for terminologies: defined in the data 402 of the terminology master database 107, the columns and lines to be checked include: the column “data” 603 in the “function_data correspondence table” in FIG. 6; the column “data” 701 in the “data_entity correspondence table” in FIG. 7; the column “data” 903 in the “applications relationship table” in FIG. 9; the column “As_Is element name” and the column “To_Be element name” 1001 of the line in which “data” is stated in the column “Classification” 1102 in the “As_Is_To_Be application correspondence table” in FIG. 10; and the column element name” 1103 of the line in which “data” is stated in the column “Classification” 1102 in the “application_infrastructure correspondence table” in FIG. 11.

As for terminologies defined in the infrastructure 403 of the terminology master database 107, the columns to be checked include the column “language” 1104 and the column “software” 1105 in the application_infrastructure correspondence table in FIG. 11.

If the EA planning results do not comply with the terminologies defined (Step 1602: NO), then the EA result analysis unit 113 displays a message to notify the user of the status, and prompts the user to modify and input the EA planning results by using pre-defined terminologies (Step 1601).

If the EA planning results comply with the terminologies defined (Step 1602: YES), then the EA result analysis unit 113 analyzes the EAplanning results (Step 1603). More specifically, the EA result analysis unit 113 first refers to the “application-function configuration table” in FIG. 8 and acquires a combination of a site and a To_Be application. Next, the EA result analysis unit 113 refers to the “As_Is_To_Be application correspondence table” in FIG. 10 regarding the application for the site thus acquired, and acquires information as to by which “function”, “data” and “function in liaison” of a future (To_Be) application, the function, data and function in liaison that are included in the current (As_Is) application can be realized respectively. Referring to the example in FIG. 10, the function “order reception” of the “marketing application” which is placed in the first line of the table in FIG. 8 is judged to be the function “order reception” of the “marketing application.”

Next, the EA result analysis unit 113 refers to the “function_data correspondence table” in FIG. 6 regarding the function name included in the “As_Is_To_Be application correspondence table” in FIG. 10, and acquires corresponding data. More specifically, the “function_data correspondence table” is used to define what data is used by each function, and the EA result analysis unit 113 checks correspondence of data for each function. If corresponding data matches for each function, then the EA result analysis unit 113 acquires the data. Taking the function “order reception” of the “marketing application” in FIG. 10 as an example, data such as “order information”, “customer information”, “commodity information” and “inquiry information” that correspond to the function “order reception” in the “function_data definition table” will be acquired.

The EA result analysis unit 113 further refers to the “application_infrastructure correspondence table” in FIG. 11, and obtains information as to by which language and database software, the function and the data that are obtained from the “As_Is_To_Be applications correspondence table” in FIG. 10 and the “function_data correspondence table” in FIG. 6 are realized. From the example in FIG. 11, it is known that the function “order reception” that is used in the “marketing application” is constructed by the “development language 1”, and the functions “order information”, “customer information”, “commodity information” and “inquiry information” are each implemented by using the “development language 1” and the “database software A.”

The EA result analysis unit 113 creates a “man-months retrieval key for each function” shown in FIG. 13 based on the information obtained through analysis in Step 1603 and stores the key in the main storage 111 (Step 1604).

Next, the EA result analysis unit 113 brings data obtained in Step 1603 together into an entity (Step 1605). More specifically, the EA result analysis unit 113 refers to the “data_entity correspondence table” in FIG. 7 by using the To_Be data name as a key, which is already checked and is to be processed, among data names included in the “data” 603 in the “function_data correspondence table” shown in FIG. 6, and acquires corresponding entities (Step 1605). Referring to the example shown in FIG. 7, three entities of “orders”, “customers” and “commodities” are acquired for four data of order information”, “customer information”, “commodity information” and “inquiry information” in FIG. 6. The EA result analysis unit 113 further refers to the “application_infrastructure correspondence table” in FIG. 11 by using the data to be processed (data that were created in Step 1604) as a key, and acquires the corresponding “software” 1105. In the example shown in FIG. 7, the “database software A” is acquired for an infrastructure that corresponds to the “order information”, the “customer information”, the “commodity information” and the “inquiry information.”

The EA result analysis unit 113 then counts the number of entities of the infrastructure acquired in Step 1605, creates the “man-months retrieval key for each database software” shown in FIG. 14, and stores the key in the main storage 111 (Step 1606).

Next, the EA result analysis unit 113 delivers the “man-months retrieval key for each function” created in Step 1604 and the “man-months retrieval key for each database software” created in Step 1606 to the man-months calculation unit 114. Thereafter, the man-months calculation unit 114 of the server 101 searches the example-basis man-months definition table 106 (FIG. 2 or 3) according to the “man-months retrieval key for each function” and the “man-months retrieval key for each database software” thus received (Step 1607).

The man-months calculation unit 114 searches the man-months definition table for each function (FIG. 2) of the man-months definition table 106 by using the “man-months retrieval key for each function”, acquires the man-months 207 corresponding to the retrieval key, and calculates man-months for each function (Step 1608). For example, the search of “man-months definition table for each function” in the example “man-months retrieval key for each function” shown in FIG. 13 reveals that “0.5 man-months” are required in terms of correspondences between As_Is “order reception” and To_Be “order reception.”

Next, the man-months calculation unit 114 searches the man-months definition for each database software (FIG. 3) by using the infrastructure name “man-months retrieval key for each database software”, acquires man-months/entity 301 corresponding to the retrieval key, and calculates man-months for the entity (Step 1609). When a referral is made to the “man-months definition for each database software” by using the infrastructure name of the “man-months retrieval key for each database software” as a key, man-months for each entity are found to be displayed. By multiplying the number of entities of the “man-months retrieval key for database software” by man-months for each entity, therefore, it is possible to calculate man-months for each infrastructure. Referring to the examples shown in FIG. 14 and FIG. 3, since the number of entities realized by the “database software A” is three, the “0.9 man·months” that can be obtained by multiplying “0.3 man months” that is available for the “database software A” in FIG. 3 by 3 will be the man-months that can be derived from the examples.

Then, the man-months calculation unit 114 calculates how many man-months should be required to realize a function, by adding up the man-months calculated in Step 1608 (the man-months that are obtained in the two methods stated above) (Step 1610). In the example stated earlier, “1.4 man·months” which is obtained by adding the “0.5 man·months” that is obtained from the “man-months definition table for each function” to the “0.9 man·months” that is obtained from the “man-months definition table for each database software” will be the man-months that is required to realize the function “order reception.”

The EA result analysis unit 113 and the man-months calculation unit 114 execute the above-stated man-months calculation for each function that is available in the application, and calculates how many man-months are required to realize one application. The EA result analysis unit 113 and the man-months calculation unit 114 further execute similar calculations on all applications that are available in the EA planning results database 108, and outputs man-months that are required to realize respective applications to the display units 123, 124 and 125 (Step 1611).

Next, the man-months calculation unit 114 prompts the user to input a priority of a particular development and development personnel for several applications that are calculated in the above-stated steps (Step 1612). The man-months calculation unit 114 creates a schedule for the particular development based on the information on the above-stated processing results (Step 1613), and outputs the schedule to the display units 123, 124 and 125 (Step 1614).

FIG. 17 shows a flow chart for retrieving past examples of a particular system development using EA. First, a user inputs all information shown in tables in FIGS. 5 to 11 as EA results via either one of the respective input units 126, 127 and 128 of the clients 103, 104 and 105. The information thus input is transferred to the server 101, and the examples retrieval unit 115 of the server 101 receives such information (Step 1701).

Next, the examples retrieval unit 115 of the server 101 refers to the As_Is_To_Be applications correspondence table (FIG. 10), and extracts “function”, “data” and “function in liaison” for each “To_Be application name” (Step 1702). For the case of FIG. 10, for example, the function of “marketing application” will be the “order reception” and the “order/sales management”, the data will be the “order information” and the “customer information”, and the function in liaison will be the “confirmation of delivery time.” Next, the examples retrieval unit 115 acquires the “development language” 1101 and the “software” 1105 which correspond the “function”, the “data” and the “function in liaison” that are extracted from the “application_infrastructure correspondence table” in FIG. 11. Referring to the example shown in FIG. 11, the function “order reception” is realized by the “development language 1”, the data “order information” uses the “development language 1” and the “database software A”, and the function in liaison “confirmation of delivery time” uses the “development language 1.” The examples retrieval unit 115 creates the “example retrieval key” shown in FIG. 15 based on such information, and stores the key in the main storage 111.

Next, the examples, retrieval unit 115 searches the content retrieval patterns database 109 (FIG. 12) by using terminologies in four columns shown in the example retrieval key in FIG. 15 as a key (Step 1703). When past examples exist (Step 1703: YES), the examples retrieval unit 115 acquires the content documents 1205 which match the example retrieval key. Referring to the example in FIG. 12, the group of terminologies at the upper block shows matching for all combinations of the “function”, the “data”, the “function in liaison” and the “infrastructure”, and a “basic design specifications No. 552” and a “detailed design specifications No. 552” will be acquired for past examples.

Next, the examples retrieval unit 115 instructs the file management unit 112 to retrieve the “basic design specifications No. 552” and the “detailed design specifications No. 552” acquired in the above-stated step. The file management unit 112 searches the particular development examples database 110 (Step 1705). The examples retrieval unit 115 displays the design documents thus obtained on any of the display unit 123, 124 and 125 as particular development examples (Step 1706).

It should be noted that, if the examples retrieval key that is stored by the examples retrieval unit 115 in the main storage 111 does not exist in the content retrieval patterns database 109 (Step 1704: NO), then the examples retrieval unit 115 outputs a message notifying that no adequate past particular development example exist to the display unit (Step 1707).

With the embodiment, in development of a particular information system after completing EA planning, it is possible, based on a calculation logic of man-months that is defined in advance, to calculate To_Be development man-months even from planning results of EA whose design size is not so fine by tracking back relationship between four layers defined in EA, without being affected by degrees of experience of development personnel. Further, according to a detection logic of particular development examples, it is possible to significantly reduce and abridge labor and time that are required for referring to past examples, by executing presentation of suitable development examples while considering matching of four EA layers.

What is claimed is:

1. A development support system which supports system development based on EA, said system comprising:
an EA planning results database which stores EA planning results about a system intended for improvement;
a man-months definition table database which stores information used for calculating man-months of system development;
a content retrieval patterns database which stores a document name that corresponds to a system development example;
a particular development examples database in which design specifications corresponding to a development example that is defined in said content retrieval patterns database are stored;
an EA result analysis unit which creates a retrieval key to search said man-months definition table database by analyzing EA planning results stored in said EA planning results database;
a man-months calculation unit which calculates development man-months by searching said man-months definition table database based on the retrieval key created by the EA result analysis unit; and
an example retrieval unit which creates an example retrieval key based on the EA planning results stored in said EA planning results database, searches said content retrieval patterns database based on the example retrieval key, and searches a development example from said particular development examples database based on the retrieval results.

2. A development support system according to claim 1,
wherein said EA includes four layers, which are a job layer (hereinafter referred to as the BA layer), a data layer (hereinafter referred to as the DA layer), an application layer (hereinafter referred to as the AA layer) and an infrastructure layer (hereinafter referred to as the TA layer); and
wherein said man-months definition table database includes a function-by-function table which stores, with respect to a function corresponding to the job included in said BA layer, data corresponding to said DA layer, and an infrastructure of said TA layer, both an AS_IS function, AS_IS data, an AS_IS infrastructure, respectively, and a TO_BE function, aTO_BE data, aTO_BE infrastructure, respectively, as a set therein; the AS_IS function, the AS_IS data, and the AS_IS infrastructure being associated with the current status of the system (hereinafter referred to as AS_IS); the TO_BE function, the TO_BE data and a TO_BE infrastructure being associated with the ideal status of the system (hereinafter referred to as TO_BE); and which stores development man-months of an application required for shifting the system to a certain system (TO_BE) from a certain system (AS_IS), in association with the set.

3. A development support system according to claim 1,
wherein said man-months definition table database includes a man-months definition table for each database software which stores man-months required for creating a certain entity and an infrastructure managing the entity in association with each other.

4. A development support system according to claim 2,
wherein said man-months calculation unit calculates man-months for each combination of AS_IS and TO_BE functions, data and infrastructures included in said man-months definition table database.

5. A development support system according to claim 1,
wherein said content retrieval patterns database defines past development examples based on a combination of a function, data, a function in liaison in a certain system; and
wherein said example retrieval unit retrieves examples according to each combination that is included in said content retrieval patterns database.

6. A development support system according to claim 2, further comprising a terminology master database which is used to define each of terminologies that are used in the BA layer, the DA layer and the TA layer.

7. A development support system according to claim 6,
wherein said EA result analysis unit judges if the EA planning results stored in said EA planning results database conform to the terminologies that are defined in said terminology master database.

8. A development support system according to claim 2,
wherein said EA planning results database includes a functional structure table used to break up and define jobs used in said BA layer in levels for each job classification.

9. A development support system according to claim 8,
wherein said EA planning results database includes a function_data correspondence table used to define what data is required for a function defined in a certain job level that is included in said functional structure table in order to associate said BA layer with said DA layer.

10. A development support system according to claim 9,
wherein said EA planning results database includes a data_entity correspondence table used to define correspondence between data stored in said function_data correspondence table and an entity defined in said DA layer.

11. A development support system according to claim 2,
wherein said EA planning results database includes an application-function configuration table used to define target sites for EA planning, applications used at each of such sites and target functions of such applications in association with one another in order to associate the BA layer with the AA layer.

12. A development support system according to claim 2,
wherein said EA planning results database includes an applications relationship table which is used to define, in association with one another, an original application, a related application, a function in liaison that links up such applications, and data that is exchanged among such applications, all of which are related to an architecture of the AA layer planned in EA.

13. A development support system according to claim 2,
wherein said EA planning results database includes an AS_IS_TO_BE applications correspondence table used to define an AS_IS application and a TO_BE application in association with each of classifications such as a function, data and a function in liaison.

14. A development support system according to claim 2,
wherein said EA planning results database includes an application_infrastructure correspondence table used to define an infrastructure to realize a function, data and a function in liaison of each application for the purpose of associating the TA layer with other three layers (the BA layer, the DA layer and the AA layer).

15. A development support system according to claim 2, further comprising:
a storage device which stores a man-months retrieval key for each function used to store an AS_IS function, AS_IS data, an AS_IS infrastructure, a TO_BE function, TO_BE data and a TO_BE infrastructure in association with one another, and a man-months retrieval key for each database software used to store the number of entities and an infrastructure name in association with each other;
wherein said EA result analysis unit searches said man-months definition table database by using a combination of items included in said man-months retrieval key for each function as a retrieval key, and by using the infrastructure name included in said man-months retrieval key for each database software as an retrieval key;
wherein said man-months calculation unit retrieves man-months of a system development by using said man-months retrieval key for each function and said man-months retrieval key for each database software.

16. A development support system according to claim 2, further comprising:
a storage device which stores a function, data, a function in liaison and an infrastructure of the system in association with one another and stores a content retrieval pattern which is a combination of the function, data, function in liaison and infrastructure of the system as a retrieval key;
wherein said example retrieval unit searches said content retrieval patterns database for an example by using said retrieval key.

17. A development support system according to claim 1, further comprising:
a client adapted to receive an input from a user;
wherein the client receives information on EA planning that is input by the user, and the information thus received is stored in said EA planning results database.

18. A method for supporting system development in a development support system which supports system development based on EA, said method comprising the steps of:
storing EA planning results related to a system to be developed in an EA planning results database;
storing information used for calculating man-months of system development in a man-months definition table database;
storing a document name corresponding to a system development example in a content retrieval patterns database;
storing design specifications corresponding to the development example that is defined in said content retrieval patterns database in a particular development examples database;
creating a retrieval key used to search said man-months definition table database by analyzing the EA planning results stored in said EA planning results database;
calculating development man-months by searching said man-months definition table database based on the retrieval key created;
creating an example retrieval key based on the EA planning results stored in said EA planning results database;
searching said content retrieval patterns database based on the example retrieval key; and
retrieving a development example from said particular development examples database based on the retrieval results.

19. A method for supporting system development according to claim 18,
wherein said EA includes four layers, which are a job layer (hereinafter referred to as the BA layer), a data layer (hereinafter referred to as the DA layer), an application layer (hereinafter referred to as the AA layer) and an infrastructure layer (hereinafter referred to as the TA layer); and
wherein said man-months definition table database includes a function-by-function table which stores, with respect to a function corresponding to the job included in said BA layer, data corresponding to said DA layer, and an infrastructure of said TA layer, both an AS_IS function, AS_IS data, an AS_IS infrastructure, respectively, and a TO_BE function, aTO_BE data, aTO_BE infrastructure, respectively, as a set therein; the AS_IS function, the. AS_IS data, and the AS_IS infrastructure being associated with the current status of the system (hereinafter referred to as AS_IS); the TO_BE function, the TO_BE data and a TO_BE infrastructure being associated with the ideal status of the system (hereinafter referred to as TO_BE); and which stores development man-months of an application required for shifting the system to a certain system (TO_BE) from a certain system (AS_IS), in association with the set;
and man-months are calculated for each combination of a function, data and an infrastructure for both AS_IS and TO_BE, the combination being included in said man-months definition table.

20. A program executed in a development support system which supports system development based on EA, said program comprising the steps of:
storing EA planning results pertaining to a system to be developed in an EA planning results database;
storing information used for calculating man-months of system development in a man-months definition table database;
storing a document name corresponding to a system development example in a content retrieval patterns database;
storing design specifications corresponding to the development example which is defined in said content retrieval patterns database in a particular development examples database;
creating a retrieval key used to search said man-months definition table database by analyzing the EA planning results stored in said EA planning results database;
calculating development man-months by searching said man-months definition table database based on the retrieval key thus created;
creating an example retrieval key based on the EA planning results stored in said EA planning results database and searching said content retrieval patterns database based on the example retrieval key; and
retrieving a development example from said particular development examples database based on the retrieval result.
